(19) United States
(12) Patent Application Publication
(10) Pub. No.: US 2005/0254786 A1
(43) Pub. Date: Nov. 17, 2005

(54) Recording and reproduction apparatus

(75) Inventor: Makoto Takano, Shiga (JP)

Correspondence Address: BACON & THOMAS, PLLC, 625 SLATERS LANE, FOURTH FLOOR, ALEXANDRIA, VA, 22314, US

(73) Assignee: Matsushita Electric Industrial Co., Ltd., Osaka (JP)

(21) Appl. No.: 11/121,947

(22) Filed: May 5, 2005

(30) Foreign Application Priority Data
May 14, 2004 (JP) 2004-144488

(51) Int. Cl. H04N 5/76

(52) U.S. Cl. 386/83; 725/58

(57) ABSTRACT

A recording and reproduction apparatus includes a receiving unit for receiving scheduling information and an ID of a scheduling information transmitting apparatus; and a registering unit for registering the scheduling information received by the receiving unit in a schedule list. Based on the scheduling information registered by the registering unit, a program is recorded by a recording unit. Further, a generating unit generates management information by adding the ID of the scheduling information transmitting apparatus to information on the program recorded by the recording unit; and the management information generated by the generating unit is stored in a recording medium by a storing unit.

### FIELD OF THE INVENTION

The present invention relates to a recording and reproduction apparatus connected to, for example, a network.

### BACKGROUND OF THE INVENTION

Recently, there have been developed diversified electronic home appliances using a network. Among them, various recording and reproduction apparatuses have been put on the market and now are drawing attention considerably. With regard to the recording and reproduction apparatuses, a scheduled recording is a very useful function, and there have been already developed methods capable of registering a scheduled recording from a remote place through a network (see, for example, Japanese Patent Laid-open Application Nos. 2001-184755 and 2001-103406).

However, the conventional methods have drawbacks in that, when a plurality of scheduling information transmitting apparatuses are connected to a recording and reproduction apparatus via a network, it cannot be determined which of the scheduling information transmitting apparatuses has initiated the recording of a specific program. Accordingly, it is impossible to selectively reproduce, delete and dub only the programs that were recorded by a command signal issued by a specific scheduling information transmitting apparatus.

### SUMMARY OF THE INVENTION

The present invention has been conceived to solve the conventional problem that, when a plurality of scheduling information transmitting apparatuses register scheduled recordings in a recording and reproduction apparatus, it is impossible to identify which of the scheduling information transmitting apparatuses has registered a scheduled recording of a specific program.

It is, therefore, an object of the present invention to provide a recording and reproduction apparatus capable of, even in case scheduling information provided from a plurality of scheduling information transmitting apparatuses are set in the recording and reproduction apparatus, identifying which program has been recorded by a command signal issued by manipulations of a specific scheduling information transmitting apparatus, by means of allowing the recording and reproduction apparatus to take an operation according to an ID of each of the scheduling information transmitting apparatuses.

In accordance with the present invention, there is provided a recording and reproduction apparatus including: a receiving unit for receiving scheduling information and an ID of a scheduling information transmitting apparatus; a registering unit for registering the scheduling information received by the receiving unit in a schedule list; a recording unit for recording a program based on the scheduling information registered by the registering unit; a generating unit for generating management information by adding the ID of the scheduling information transmitting apparatus to information of the program recorded by the recording unit; and a storing unit for storing the management information generated by the generating unit in a recording medium.

### BRIEF DESCRIPTION OF THE DRAWINGS

The above and other objects and features of the present invention will become apparent from the following description of preferred embodiments given in conjunction with the accompanying drawings, in which:

FIG. 1 provides a block diagram to describe a configuration of a recording and reproduction apparatus and a scheduling information transmitting apparatus in accordance with a first preferred embodiment of the present invention; and

FIG. 2 sets forth a block diagram to describe a configuration of a recording and reproduction apparatus of a dubbing destination and a recording and reproduction apparatus of a dubbing source in accordance with a second preferred embodiment of the present invention.

### DETAILED DESCRIPTION OF THE PREFERRED EMBODIMENTS

A recording and reproduction apparatus in accordance with the present invention takes an operation according to an ID of a scheduling information transmitting apparatus when scheduling information for a scheduled recording is registered via a network. Accordingly, it becomes possible to identify the programs recorded by manipulations of a specific scheduling information transmitting apparatus even when multiple programs are recorded in the recording and reproduction apparatus based on scheduling information provided from a plurality of scheduling information transmitting apparatuses.

### First Preferred Embodiment

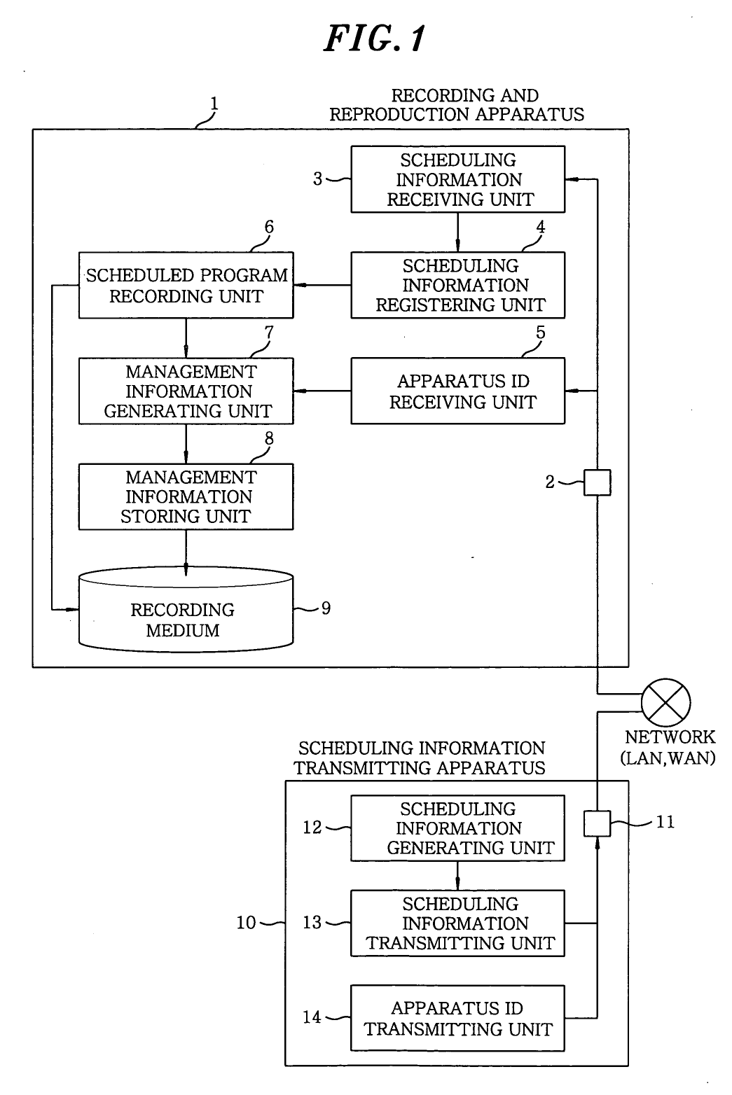

As shown in FIG. 1, in accordance with the first preferred embodiment of the present invention, recording and reproduction apparatus 1 includes network interface 2, scheduling information receiving unit 3, scheduling information registering unit 4, apparatus ID receiving unit 5, scheduled program recording unit 6, management information generating unit 7, management information storing unit 8 and recording medium 9. Further, scheduling information transmitting apparatus 10 (scheduling information registration apparatus) includes network interface 11, scheduling information generating unit 12, scheduling information transmitting unit 13 and apparatus ID transmitting unit 14.

A process for registering scheduling information in recording and reproduction apparatus 1 with use of scheduling information transmitting apparatus 10 will now be described. A user creates scheduling information by using scheduling information generating unit 12 of scheduling information transmitting apparatus 10. Here, the scheduling information refers to information specifying a recording in the recording and reproduction apparatus. The scheduling information may include, for example, information on a channel, time to begin the recording, time to finish the recording, and so forth. Or, the scheduling information may include, e.g., a program ID that identifies a program. Moreover, in recording and reproduction apparatus 1, a program schedule display unit or the like may be further prepared in order to help the user create the scheduling information. The scheduling information created by the user is sent to network interface 11 via scheduling information transmitting unit 13, while an apparatus ID of scheduling information transmitting apparatus 10 is also sent to network interface 11 by apparatus ID transmitting unit 14. The scheduling information and the apparatus ID are transmitted to network interface 2 of recording and reproduction apparatus 1 via a network (e.g., a local area network (LAN) or a wide area network (WAN)). The transmitted scheduling information is received by scheduling information receiving unit 3 of recording and reproduction apparatus 1, and thus received scheduling information is registered in a schedule list by scheduling information registering unit 4. Meanwhile, the apparatus ID is received by apparatus ID receiving unit 5. The received apparatus ID is stored, e.g., in the schedule list to be related with the received scheduling information, and is used to generated a management information when a program is recorded based on the scheduling information, which will be described below. In this way, there comes an advantage in that it can be easily accomplished to retrieve or cancel only the scheduling information registered by a specific scheduling information transmitting apparatus.

Scheduled program recording unit 6 performs a recording of a program based on the scheduling information registered by scheduling information registering unit 4. Then, upon the completion of the recording, management information generating unit 7 generates management information by adding the apparatus ID, which is provided from apparatus ID receiving unit 5, to program information provided from scheduled program recording unit 6. Then, management information storing unit 8 stores the management information, which has been created by management information generating unit 7, in recording medium 9. Here, the program information refers to metadata for the program, which may include, for example, a name, a length and date and time of recording the program, but not limited thereto.

In accordance with the first preferred embodiment of the present invention, even in case the recording and reproduction apparatus receives scheduling information from a plurality of scheduling information transmitting apparatuses, it is possible to identify which of the scheduling information transmitting apparatuses has initiated the recording of a certain program. Therefore, reproduction, deletion and dubbing of the programs that have been recorded by manipulations of a specific scheduling information transmitting apparatus can be performed easily.

Since, in accordance with the present invention, it can be easily determined which of multiple scheduling information transmitting apparatuses has initiated a recording of a specific program, the usability of a recording and reproduction apparatus connected to the scheduling information transmitting apparatuses via a network can be improved considerably.

Although the preferred embodiment of the present invention has been described for the case where each scheduling information transmitting apparatus is connected to the recording and reproduction apparatus via a network (LAN, WAN), same effect can be obtained, in case a plurality of scheduling information transmitting apparatuses such as individual remote controllers are communicating with a recording and reproduction apparatus even if not through the network (LAN, WAN).

Moreover, in the first preferred embodiment, the IDs of the scheduling information transmitting apparatuses are stored as the management information in the recording and reproduction apparatus. However, it is also possible to identify the scheduling information transmitting apparatuses by employing various other methods. For example, instead of the IDs of the scheduling information transmitting apparatuses, any IDs having one-to-one correspondence with the apparatuses may be stored as the management information in the recording and reproduction apparatus. Or, programs may be recorded in folders respectively corresponding to the scheduling information transmitting apparatuses. Alternatively, the programs may be registered in play lists respectively corresponding to the scheduling information transmitting apparatuses.

### Second Preferred Embodiment

Though the present invention has been described so far with respect to a recording and reproduction apparatus connectable to a plurality of scheduling information transmitting apparatuses, the present invention may be applied to a case of using a recording and reproduction apparatus of a dubbing source and a recording and reproduction apparatus of a dubbing destination.

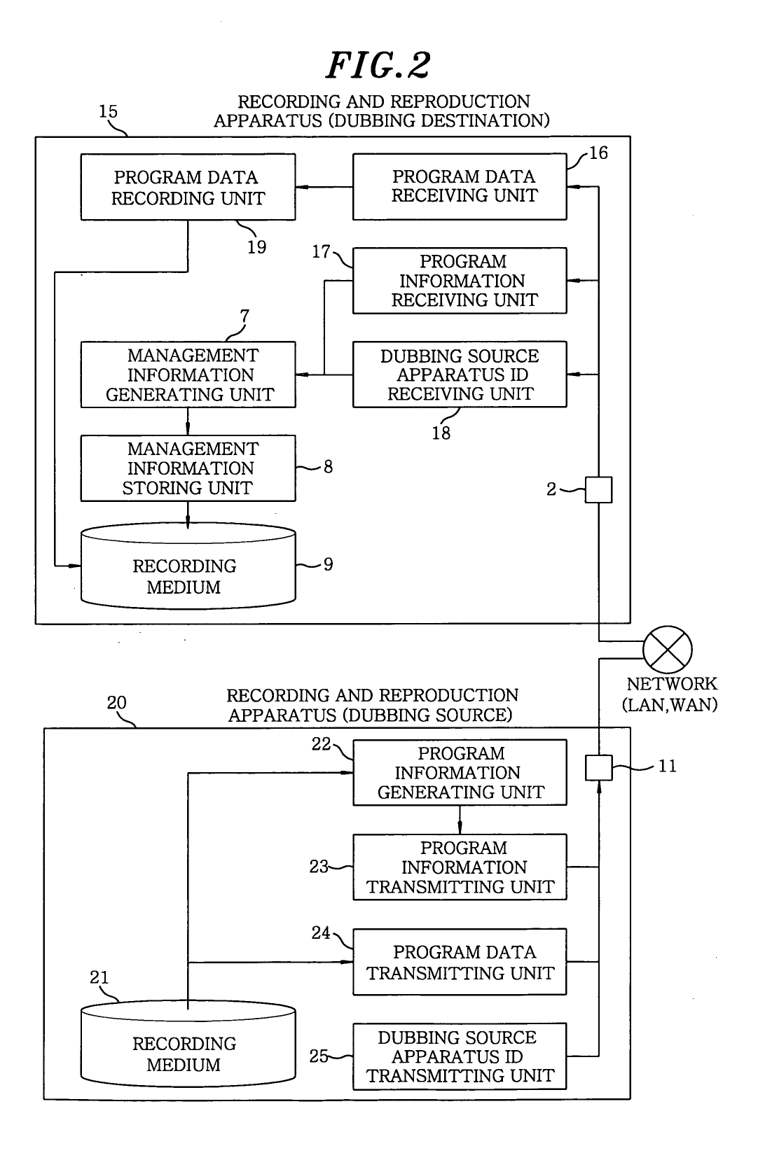

FIG. 2 describes a second preferred embodiment of the present invention. Recording and reproduction apparatus of dubbing destination 15 includes network interface 2, management information generating unit 7, management information storing unit 8, recording medium 9, program data receiving unit 16, program information receiving unit 17, dubbing source apparatus ID receiving unit 18, and program data recording unit 19. Further, recording and reproduction apparatus of dubbing source 20 includes network interface 11, recording medium 21, program information generating unit 22, program information transmitting unit 23, program data transmitting unit 24 and dubbing source apparatus ID transmitting unit 25.

Hereinafter, a process for recording a program, which is stored in recording medium 21 of recording and reproduction apparatus of dubbing source 20, in recording medium 9 of recording and reproduction apparatus of dubbing destination 15 via a network (LAN, WAN) will be described. Information on a program stored in recording medium 21 of a dubbing source is generated by program information generating unit 22 and then is sent to network interface 11 by program information transmitting unit 23. Here, the program information, i.e. the information on the program, refers to metadata for the program, which may include, for example, a name, a length and date and time of recording the program, but not limited thereto. Further, program data stored in recording medium 21 is transmitted to network interface 11 by program data transmitting unit 24. Meanwhile, information for identifying the dubbing source apparatus (namely, a dubbing source apparatus ID) is also sent to network interface 11 by dubbing source apparatus ID transmitting unit 25.

Recording and reproduction apparatus of dubbing destination 15 operates as follows. In recording and reproduction apparatus of dubbing destination 15, program data receiving unit 16, program information receiving unit 17 and dubbing source apparatus ID receiving unit 18 receive the program data, the program information and the dubbing source apparatus ID, respectively. Then, program data recording unit 19 records the received program data in recording medium 9, and management information generating unit 7 generates management information based on the program information and the dubbing source apparatus ID. Thus created management information is stored in recording medium 9 by management information storing unit 8.

In accordance with the second preferred embodiment of the present invention, when plural programs sent from a plurality of recording and reproduction apparatuses of dubbing sources are dubbed in a recording medium of a recording and reproduction apparatus of a dubbing destination, it can be determined which of the recording and reproduction apparatuses of dubbing sources has served as a dubbing source for a certain program. Therefore, reproduction, dubbing and deletion of programs, which have been dubbed from a specific recording and reproduction apparatus of a dubbing source, can be performed conveniently.

Since the present embodiment enables a determination of a recording and reproduction apparatus that has served as the dubbing source for a certain program stored in a recording and reproduction apparatus of a dubbing destination, a usability of a recording and reproduction apparatus connected to recording and reproduction apparatuses of dubbing sources can be improved considerably.

In accordance with the present embodiment, for the identification of recording and reproduction apparatuses of dubbing sources, IDs thereof are stored as management information in a recording and reproduction apparatus of a dubbing destination. Additionally, a dubbing history of each program may be investigated, by allowing IDs of one or more recording and reproduction apparatuses, which serves as dubbing sources of the program, to be stored as management information in the recording and reproduction apparatus of the dubbing destination. For instance, the program information for a specific program generated by program information generating unit 22 may include a previous dubbing history thereof, namely, a list of IDs that represents recording and reproduction apparatuses of dubbing sources by which the program has been dubbed; and, management information generating unit 7 may generate management information that includes therein a new dubbing history, that is, the previous dubbing history and an ID of a current recording and reproduction apparatus of a dubbing source.

Further, in the second preferred embodiment, IDs of recording and reproduction apparatuses of dubbing sources are stored as management information in a recording and reproduction apparatus of a dubbing destination. However, various other methods may be employed for the identification thereof. For example, IDs, not identical to the IDs of the recording and reproduction apparatuses of the dubbing sources but having one-to-one correspondence with them, may be stored as the management information in the recording and reproduction apparatus of the dubbing destination. Or, another method may be employed that programs are recorded in folders respectively corresponding to the recording and reproduction apparatuses of the dubbing sources. Alternatively, the programs may be registered in play lists respectively corresponding to the recording and reproduction apparatuses of the dubbing sources.

Furthermore, though the first and the second preferred embodiments of the present invention have been described with respect to a recording and reproduction apparatus connected to scheduling information transmitting apparatuses or recording and reproduction apparatuses of dubbing sources via the network, means to connect them is not limited to the network.

The recording and reproduction apparatus in accordance with the present invention registers an ID of a scheduling information transmitting apparatus or an ID of a recording and reproduction apparatus of a dubbing source when a scheduled recording or a dubbing of a program is performed using a network. Therefore, the present invention may be applied to various AV (audio/video) appliances connectable to the network.

While the invention has been shown and described with respect to the preferred embodiments, it will be understood by those skilled in the art that various changes and modifications may be made without departing from the spirit and scope of the invention as defined in the following claims.

1. A recording and reproduction apparatus comprising:
a receiving unit for receiving scheduling information and an ID of a scheduling information transmitting apparatus;
a registering unit for registering the scheduling information received by the receiving unit in a schedule list;
a recording unit for recording a program based on the scheduling information registered by the registering unit;
a generating unit for generating management information by adding the ID of the scheduling information transmitting apparatus to information on the program recorded by the recording unit; and
a storing unit for storing the management information generated by the generating unit in a recording medium.

2. A recording and reproduction apparatus comprising:
a recording medium for storing therein program data and management information;
a receiving unit for receiving program data, program information of a program, and an ID of a recording and reproduction apparatus of a dubbing source;
a recording unit for recording the program data received by the receiving unit in the recording medium;
a generating unit for generating management information by adding the ID of the recording and reproduction apparatus of the dubbing source received by the receiving unit to the program information received by the receiving unit; and
a storing unit for storing the management information generated by the generating unit in the recording medium.

3. The apparatus of claim 1, further comprising a remote controller for initiating the recording, wherein an ID of the remote controller is added to the program information.

4. The apparatus of claim 1, wherein, in case the program is scheduled to be recorded, the program is recorded in a folder corresponding to the ID of the scheduling information transmitting apparatus.

5. The apparatus of claim 2, wherein, in case the program is dubbed, the management information includes IDs of recording and reproduction apparatuses that represent dubbing history of the program.

6. The apparatus of claim 2, wherein, in case the program is dubbed, the program is recorded in a folder corresponding to the ID of the recording and reproduction apparatus of the dubbing source.

7. The apparatus of claim 1, wherein, in case the program is scheduled to be recorded, the program is recorded in a play list corresponding to the ID of the scheduling information transmitting apparatus.

8. The apparatus of claim 2, wherein, in case the program is dubbed, the program is registered in a play list corresponding to the ID of the recording and reproduction apparatus of the dubbing source.

9. The apparatus of claim 3, wherein, in case the program is recorded through the use of the remote controller, the program is registered in a play list corresponding to the ID of the remote controller.
